(19) United States
(12) Patent Application Publication
(10) Pub. No.: US 2015/0010288 A1
(43) Pub. Date: Jan. 8, 2015

(54) MEDIA INFORMATION SERVER, APPARATUS AND METHOD FOR SEARCHING FOR MEDIA INFORMATION RELATED TO MEDIA CONTENT, AND COMPUTER-READABLE RECORDING MEDIUM

(71) Applicant: Samsung Electronics Co., Ltd., Gyeonggi-do (KR)

(72) Inventors: Amit Aggarwal, Gyeonggi-do (KR); Dong-Hyun Yeom, Gyeonggi-do (KR)

(73) Assignee: Samsung Electronics Co., Ltd., Gyeonggi-do (KR)

(21) Appl. No.: 14/204,991

(22) Filed: Mar. 11, 2014

(30) Foreign Application Priority Data
Jul. 3, 2013 (KR) 10-2013-0078011

(51) Int. Cl. G06F 17/30; G11B 27/19

(52) U.S. Cl. CPC G06F 17/30784; G11B 27/19
USPC 386/240

(57) ABSTRACT

A method for searching for media information related to media content includes selecting at least one frame included in a plurality of frames from the media content, extracting at least one text information included in each of the selected at least one frame, and requesting media information related to the media content using the extracted at least one text information. An apparatus for searching for media information related to media content includes a storage unit configured to store information about at least one media content, and a controller configured to select at least one frame from a plurality of frames included in the media content, extract at least one text information included in each of the selected at least one frame, and request media information related to the media content using the extracted at least one text information.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Jul. 3, 2013 and assigned Serial No. 10-2013-0078011, the entire disclosure of which is incorporated herein by reference.

### TECHNICAL FIELD

Embodiments of the present disclosure relate generally to electronic devices, and more particularly, to a media information server for searching for and providing media information related to media content, an apparatus and method for searching for media information related to media content, and a computer-readable recording medium thereof.

### BACKGROUND

In general, an Internet is an open network configured to allow anyone to freely access a desired computer of the other side using a common protocol called Transmission Control Protocol/Internet Protocol (TCP/IP) anywhere in the world. The Internet is used not only for the delivery of text information, but also for delivery of media information with the development of compression technology, allowing users to enjoy various services such as E-mail, file transfer and World Wide Web (WWW).

As the use of the Internet has dramatically increased worldwide, the Internet serves as a strategic tool for increasing the efficiency and productivity across all parts of existing industry and its importance has increased rapidly. Many Internet-based new business opportunities have been created and their related business areas have also expanded, causing a dramatic increase in the number of Internet service providers.

Media content such as video can be played by a media playback program installed in an electronic device such as a Personal Computer (PC), a portable device, or can be played on a dedicated media playback device.

The media content has metadata that a content creator inserted in it during content creation, or includes the simple basic information (e.g., a running time, a content creation date and the like) related to the media content, which is generated during content creation. Therefore, in order to obtain more specific information related to the media content, annoyingly, the user needs to search for the information over the Internet.

For example, in order to obtain subtitle information as media information related to the media content, the user needs to directly search for and download a subtitle file. More specifically, the user needs to search for and download subtitle information over the Internet using a media file's name, a content title or the like, and save the downloaded subtitle information in the directory in which the media content is stored. Thereafter, if the user plays the media content by executing a predetermined media playback program, the downloaded subtitle information is displayed on the screen by being synthesized with the media content.

Another way to search for information related to media content can allow an application (e.g., a separate subtitle search application, a media playback program or the like) to automatically search for a subtitle file over the Internet using a file mane of the media content as a keyword.

FIG. 1 illustrates a program execution screen for obtaining the media content-related information. Referring to FIG. 1, if a predetermined subtitle search application searches for a subtitle using a file name “The Replacement Killers” as a keyword, files in the format of a subtitle file ‘sub’ or a text file ‘txt’ are searched for over the Internet as illustrated in the drawing.

However, these media content-related information (e.g., subtitle information) search methods are highly likely to mis-search for the information since they make the search by simply using only the file name of the media content. As a result, incorrect information can be searched. For example, if a specific user changes a file name while the media content is distributed, it is hard for other users to obtain correct subtitle information for the media content, and if there are many different media contents having the same or similar file name(s), incorrect subtitle information can be searched.

Therefore, there is a need for a way to automatically search for the most-appropriate and highly-reliable media content-related information.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object of the present disclosure to address at least the above-mentioned problems and/or disadvantages and to provide at least the advantages described below. Accordingly, certain embodiments of the disclosure provide a media info illation server capable of automatically searching for the most-correct and appropriate media information by extracting text information included in a specific frame in media content and searching for related media information using the extracted text information, an apparatus and method for searching for media information related to media content, and a computer-readable storage medium thereof.

Certain embodiments of the disclosure provide a media info illation server capable of automatically searching for the most-correct and appropriate media information by extracting text information included in a specific frame in media content and searching for related media information using the extracted text information and metadata included in the media content, an apparatus and method for searching for media information related to media content, and a computer-readable storage medium thereof.

Certain embodiments of the disclosure provide a media information server capable of automatically searching for the most-correct and appropriate media information by extracting text information included in a specific frame in media content and searching for related media information using the extracted text information and image information of a specific key frame, an apparatus and method for searching for media information related to media content, and a computer-readable recording medium thereof.

Certain embodiments of the disclosure provide a media information server capable of automatically searching for the most-correct and appropriate media information by extracting text information included in a specific frame in media content and searching for related media information using the extracted text information and information about the time the text information is extracted, an apparatus and method for searching for media information related to media content, and a computer-readable recording medium thereof.

Certain embodiments of the disclosure provide a media information server capable of automatically searching for the most-correct and appropriate media information by extracting text information included in a specific frame in media content and searching for related media information using the extracted text information and information about the time a voice is first output, an apparatus and method for searching for media information related to media content, and a computer-readable recording medium thereof.

Certain embodiments of the disclosure provide a method for searching for media information related to media content. The method includes selecting at least one frame from the plurality of frames included in the media content; extracting at least one text information included in each of the selected at least one frame; and requesting media information related to the media content using the extracted at least one text information.

The media information related to the media content can include subtitle information of the media content.

The selecting of the at least one frame can include searching for key frames in ascending order, beginning from a start frame of the media content; and selecting a first key frame including a text.

After the selecting of the first key frame including a text, the method can further include selecting a predetermined number of subsequent key frames which are separated from each other by a preset time interval.

The selecting of the at least one frame can include searching for key frames in descending order, beginning from an end frame of the media content; and selecting a first key frame including a text.

After the selecting of the first key frame including a text, the method can further include selecting a predetermined number of preceding key frames which are separated from each other by a preset time interval.

The method can further include extracting at least one image included in the media content; and requesting media information related to the media content using the extracted at least one image in addition to the extracted at least one text information.

The extracting of the at least one image can include extracting an image corresponding to a preset time of a total running time of the media content.

The method can further include extracting at least one metadata included in the media content; and requesting media information related to the media content using the extracted at least one metadata in addition to the extracted at least one text information.

The metadata can include information about any selected one of a file name, a running time, a frame size, an audio data size, a video data size, a frame rate, an aspect ratio of pixels, key frame information, a video codec, and an audio codec.

The method can further include extracting time information of a frame from which the text information is extracted; and requesting media information related to the media content using the extracted time information in addition to the extracted at least one text information.

The method can further include extracting information about a time that a voice is first output, from the media content; and requesting media information related to the media content using the extracted time information in addition to the extracted at least one text information.

Certain embodiments of the disclosure provide an apparatus for searching for media information related to media content. The apparatus includes a storage unit for storing information about at least one media content; and a controller for selecting at least one frame from a plurality of frames of the media content, extracting at least one text information included in each of the selected at least one frame, and requesting media information related to the media content using the extracted at least one text information.

The media information related to the media content can include subtitle information of the media content.

The controller can search for key frames in ascending order, beginning from a start frame of the media content, and select a first key frame including a text.

After selecting the first key frame including a text, the controller can select a predetermined number of subsequent key frames which are separated from each other by a preset time interval.

The controller can search for key frames in descending order, beginning from an end frame of the media content, and select a first key frame including a text.

After selecting the first key frame including a text, the controller can select a predetermined number of preceding key frames which are separated from each other by a preset time interval.

The controller can extract at least one image included in the media content, and request media info illation related to the media content using the extracted at least one image in addition to the extracted at least one text information.

The controller can extract an image corresponding to a preset time of a total running time of the media content.

The controller can extract at least one metadata included in the media content, and request media information related to the media content using the extracted at least one metadata in addition to the extracted at least one text information.

The metadata can include information about any selected one of a file name, a running time, a frame size, an audio data size, a video data size, a frame rate, an aspect ratio of pixels, key frame information, a video codec, and an audio codec.

The controller can extract time information of a frame from which the text information is extracted, and request media information related to the media content using the extracted time information in addition to the extracted at least one text information.

The controller can extract information about a time that a voice is first output, from the media content, and request media information related to the media content using the extracted time information in addition to the extracted at least one text information.

Certain embodiments of the disclosure provide a media information server for providing media information related to media content. The media information server includes a media information database in which at least one media information is stored by being mapped to each media content; a request information receiver for receiving a media information request message transmitted from each media content playback device; a media information searcher for searching for media information stored in the media information database using at least one information included in the received media information request message; and a media information transmitter for transmitting the media information searched for by the media information searcher to the media content playback device. The media information request message can include text information that is extracted from at least one frame selected from the media content including a plurality of frames.

The media information request message can further include at least one image information extracted from the media content, and the media information searcher re-searches for media information using the image information, if the media information searcher fails to search for media information using text information included in the received media information request message.

A computer-readable recording medium can store a program for performing the method of searching for media information related to media content. The recording medium can include a program that can be read by a computer system, and all kinds of recording media in which data is stored. Examples of the recording medium can include Read Only Memory (ROM), Random Access Memory (RAM), Compact Disk (CD), Digital Video Disk (DVD)-ROM, magnetic tape, floppy disk, optical data storage, embedded Multi Media Card (eMMC), and the like, and can also include a medium implemented in the form of carrier waves (e.g., transmission over the Internet). The recording medium can be distributed over the computer systems connected by the network, and a computer-readable code can be stored and executed in the recording medium in a distributed manner.

Other aspects, advantages, and salient features of the disclosure will become apparent to those skilled in the art from the following detailed description, which, taken in conjunction with the annexed drawings, discloses certain embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts: The above and other aspects, features and advantages of certain embodiments of the present disclosure will be more apparent from the following description taken in conjunction with the accompanying drawings, in which:

FIG. 1 illustrates a program execution screen for obtaining media content-related information;

FIG. 2 illustrates the concept of obtaining information related to media content according to certain embodiments of the present disclosure;

FIG. 3 illustrates a system for searching for media information related to media content according to certain embodiments of the present disclosure;

FIG. 4 is a block diagram illustrating a detailed structure of a media content playback device according to certain embodiments of the present disclosure;

FIG. 5 is a block diagram illustrating a detailed structure of a media information server according to certain embodiments of the present disclosure;

FIG. 6 illustrates a procedure for searching for media information related to media content according to certain embodiments of the present disclosure;

FIG. 7 illustrates frames which are searched for beginning from a start frame according to certain embodiments of the present disclosure;

FIG. 8 illustrates frames which are searched for beginning from an end frame according to certain embodiments of the present disclosure;

FIG. 9 illustrates a procedure for extracting a text by searching for frames in ascending order, beginning from a start frame according to certain embodiments of the present disclosure;

FIG. 10 illustrates a procedure for extracting a text by searching for frames in descending order, beginning from an end frame according to certain embodiments of the present disclosure;

FIGS. 11 and 12 illustrate text extraction from key frames according to certain embodiments of the present disclosure;

FIG. 13 illustrates a procedure for searching for media information related to media content according to certain embodiments of the present disclosure;

FIG. 14 illustrates a procedure for searching for media information related to media content according to certain embodiments of the present disclosure;

FIG. 15 illustrates a procedure for searching for media information related to media content according to certain embodiments of the present disclosure;

FIG. 16 illustrates a procedure for searching for media information related to media content according to certain embodiments of the present disclosure;

FIG. 17 illustrates a frame which is searched for beginning from a start frame and an end frame on a media content playback screen according to certain embodiments of the present disclosure;

FIGS. 18A to 18C illustrate frames which are searched for in ascending order, beginning from a start frame and in which texts are included; and

FIGS. 19A to 19D illustrate frames which are searched for in descending order, beginning from an end frame and in which texts are included.

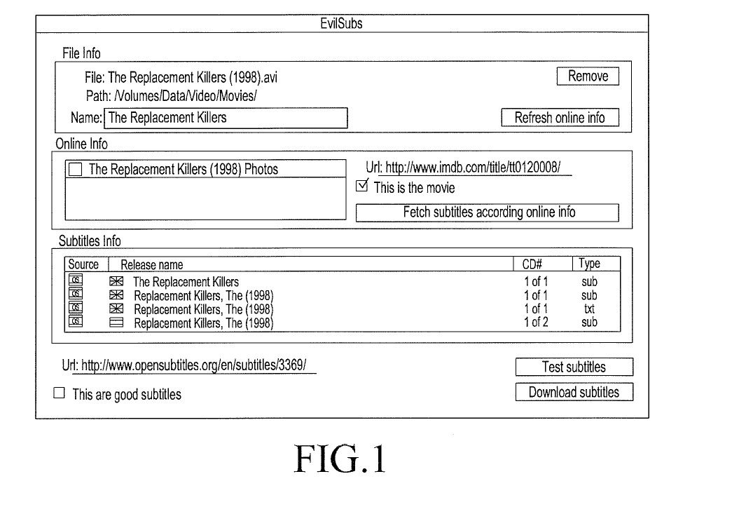

Throughout the drawings, like reference numerals will be understood to refer to like parts, components, and structures.

### DETAILED DESCRIPTION

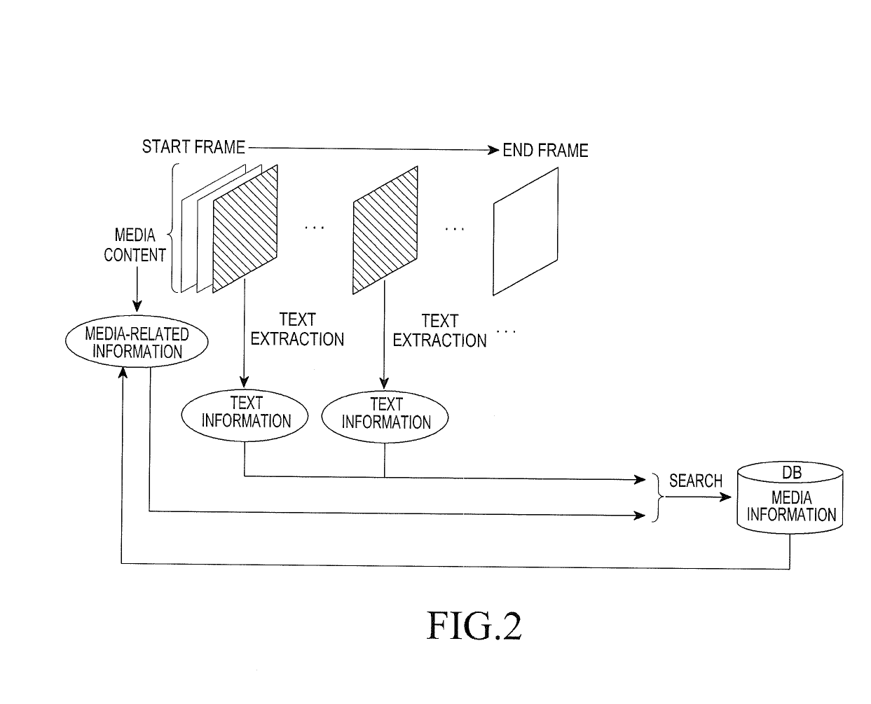

FIGS. 2 to 19D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged networked communication device. The following description with reference to the accompanying drawings is provided to assist in a comprehensive understanding of embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to help those skilled in the art to better understand the present disclosure, certain embodiments of the present disclosure will be described in detail with reference to the accompanying drawings.

FIG. 2 illustrates the concept of obtaining information related to media content according to certain embodiments of the present disclosure. Referring to FIG. 2, this method of searching for media information related to media content according to certain embodiments of the present disclosure can extract text information from at least one specific frame among a plurality of frames (e.g., image frame), and search for media information using the extracted text information.

In the below-described embodiments of the present disclosure, the term ‘media content’ as used herein may refer to the broadest concept of the content that can be played for a predetermined period of time, and can include video and the like as an example thereof. The media content can be stored in a storage unit in the form of a file, but the present disclosure is not limited thereto.

In embodiments of the present disclosure, media content can be comprised of a plurality of frames as illustrated in FIG. 2, and the frame that is played first during playback of the media content may be referred to as a ‘start frame’, while the frame that is played last may be referred to as an ‘end frame’. Embodiments of the present disclosure can search for related media information by extracting a text(s) included in at least one frame between the start frame and the end frame. Among the plurality of frames included in the media content, frames including text information and frames including no text information can exist in a mixed way. Therefore, the present disclosure can extract text information from a frame including the text information among the plurality of frames and use it as a search keyword for searching for media information.

For the search for the media information, the text information extracted from a specific frame can be used according to certain embodiments of the present disclosure. In accordance with various embodiments of the present disclosure, the search can be made in combination of metadata included in media content, an image of a specific key frame, time information of a frame from which text information is extracted, information about the time a voice is first output, and the like. The metadata is information which is included in or related to media content, and can be distributed by being included in a media content file. The metadata can include information about at least one of a file name, a running time, a frame size, an audio data size, a video data size, a frame rate, an aspect ratio of pixels, key frame information, a video codec, an audio codec, and the like.

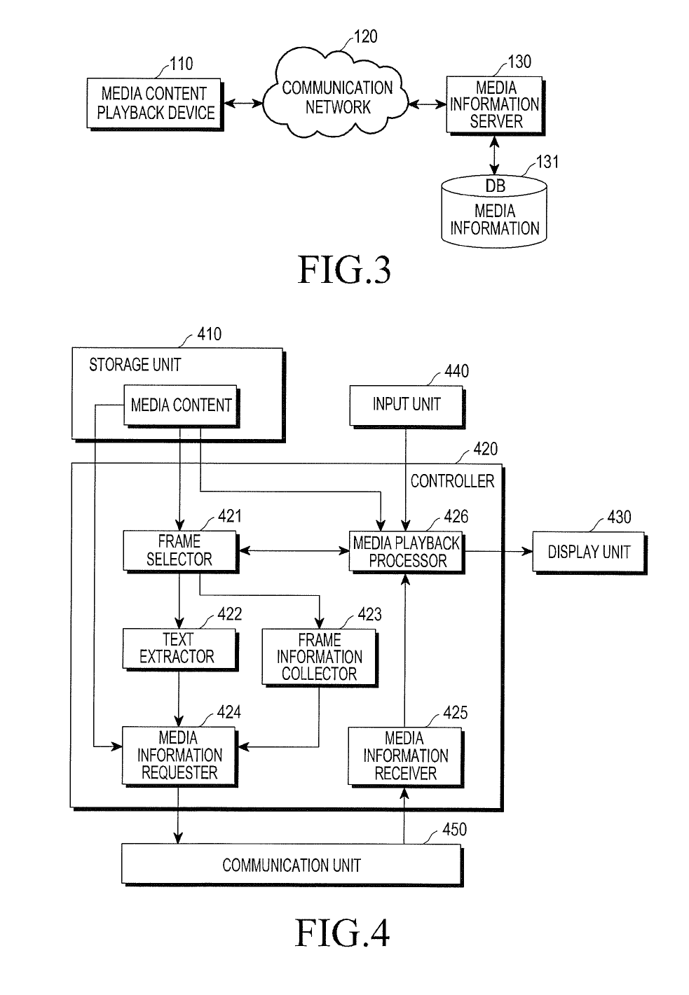

As such, the media information stored in a media information database can be searched for by using the variety of information extracted from media content as keywords. The media information database can be implemented to be searched through the Internet by being connected to a separate server other than a media content playback device (or media information search device) as illustrated in FIG. 3. Alternatively, the media information stored in the media information database can be implemented to make the search in the device by being stored in a storage unit in the media content playback device (or media information search device). In other words, in the media information database can be stored media content identification information for identifying specific media content and media information corresponding to each media content identification information by being mapped to each other. Therefore, if specific media content is identified by the search, media information which is stored by being mapped to the identified media content can be provided as a result of the search.

The media information mapped to the media content can be subtitle information, and any other information related to the media content can be media information according to certain embodiments of the present disclosure.

In the below-described various embodiments of the present disclosure, subtitle information is given as a specific example of media information provided as a result of the search, by way of example, but the present disclosure is not limited thereto.

Reference will first be made to FIGS. 3 to 5 to describe the structure of system and apparatus according to certain embodiments of the present disclosure, and reference will next be made to FIGS. 6 to 19 to describe in detail the procedures and implementations according to certain embodiments of the present disclosure.

FIG. 3 illustrates a system for searching for media information related to media content according to certain embodiments of the present disclosure. Referring to FIG. 3, the system can include a media content playback device 110, a communication network 120, a media information server 130, and a media information database 131.

The media content playback device 110 performs a function of playing specific media content selected by a user, and may refer to either a dedicated device for playing media content as described above, or an application installed in a computer or a portable device in the form of a program. Although the media content playback device 110 is illustrated in FIG. 3, it can be replaced by a media information search device for making only the search for information related to media content without including the media content playback function according to certain embodiments of the present disclosure. In other words, in accordance with certain embodiments of the present disclosure, the media content playback device 110 can perform both the media content playback function and the media information search function, and the device for media content playback and the device for media information search can be configured by separate software or hardware.

For example, the media content playback device 110, which is any device equipped with an operation means (e.g., a controller), can be any one of a digital camera, a smart phone, a cellular phone, a game console, a Television (TV), a display device, a car head unit, a notebook computer, a laptop computer, a tablet computer, a Personal Media Player (PMP), a Personal Digital Assistants (PDA), a navigation device, a bank Automatic Teller Machine (ATM), a store's Point of Sales (POS) device and the like. The media content playback device 110 can also be a flexible device or a flexible display device.

In accordance with various certain embodiments of the present disclosure, the media content playback device 110 can transmit at least one piece of information for the search to the media information server 130 through the communication network 120, and receive media information from the media information server 130 through the communication network 120 as a result of the search.

In other words, the media information server 130 can receive at least one information (e.g., text information included in a frame of media content according to certain embodiments of the present disclosure) from the media content playback device 110, and search for media information stored in the media information database 131 using the received information as a keyword. Thereafter, the media information server 130 provides the searched media information to the media content playback device 110 through the communication network 120.

Although it is assumed in FIG. 3 that the media content playback device 110 requests a search for related media information from the media information server 130 through the communication network 120, the media content playback device 110 can be implemented to directly search for media information stored therein according to certain embodiments of the present disclosure.

The communication network 120 can be configured regardless of its communication mode such as a wired communication mode and a wireless communication mode, and can be configured as any one of various communication networks such as a Personal Area Network (PAN), a Local Area Network (LAN), a Metropolitan Area Network (MAN), a Wide Area Network (WAN) and the like. The communication network 120 can be the known World Wide Web (WWW), and can use wireless transmission technology which is used for short-range communication such as Infrared Data Association (IrDA) and Bluetooth.

In the media information database 131 can be stored various media information corresponding to each media content in such a manner that at least one media information is mapped to specific media content. Therefore, the media information database 131 can identify media content corresponding to the information (e.g., information extracted from media content, information stored together with media content, and the like) transmitted from the media content playback device 110, and transmit media information (e.g., subtitle information and the like) mapped to the identified media content and stored therein, to the media content playback device 110.

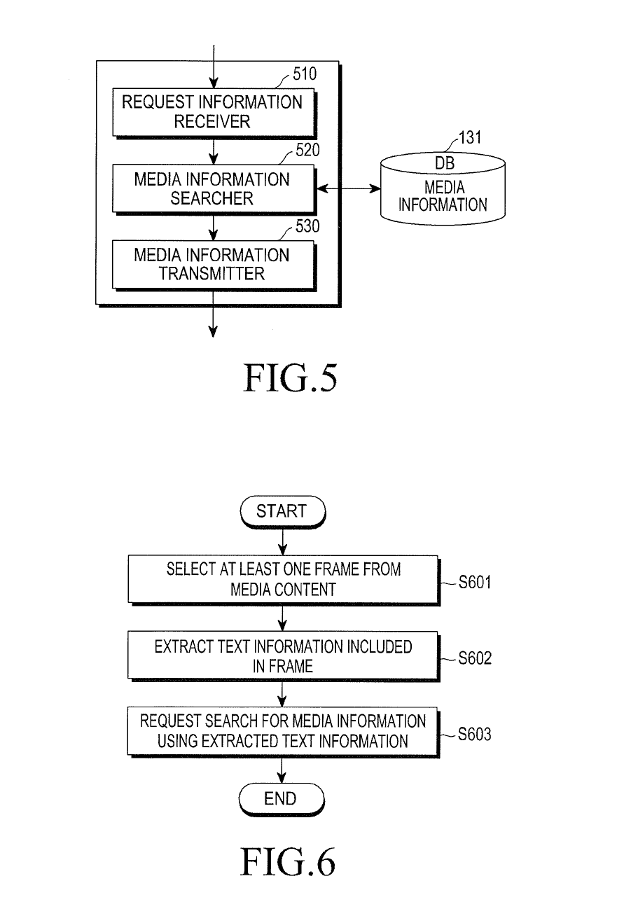

Reference will now be made to FIGS. 4 and 5 to describe in detail the detailed structure of the media content playback device 110 and the media information server 130.

FIG. 4 is a block diagram illustrating a detailed structure of a media content playback device 110 according to certain embodiments of the present disclosure. Referring to FIG. 4, the media content playback device 110 can include a storage unit 410, a controller 420, a display unit 430, an input unit 440, and a communication unit 450.

The storage unit 410 can store media content, and can further store media information related to the media content. If the storage unit 410 stores both the media content and the media information mapped thereto, the media content playback device 110 can search for media information by itself without requesting the search for media information from the media information server 130.

In accordance with certain embodiments of the present disclosure, the controller 420 can request a search for media information related to media content, and receive the search results. The controller 420 can include any one or more of a frame selector 421, a text extractor 422, a frame information collector 423, a media information requester 424, a media information receiver 425, and a media playback processor 426.

The frame selector 421 can select a specific frame, from which a text(s) is to be extracted, from among a plurality of frames constituting media content. How the frame selector 421 selects a frame can be implemented in various ways according to certain embodiments of the present disclosure.

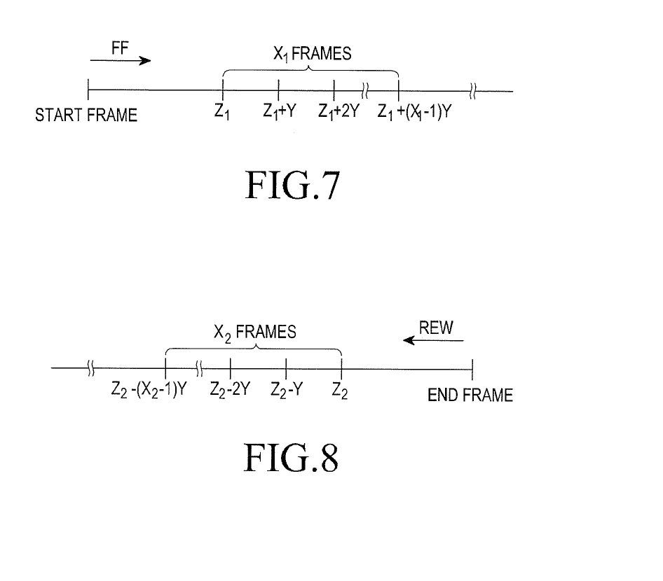

For example, the frame selector 421 can search for key frames in ascending order, beginning from a start frame of media content, and select, as a frame for text extraction, the frame which includes a text and is searched for the first time. In accordance with certain embodiments, the frame selector 421 can search for key frames in descending order, beginning from an end frame of media content, and select, as a frame for text extraction, the frame which includes a text and is searched for the first time. The frame selector 421 can select one frame, and can also select two or more frames. Specific examples thereof will be described below with reference to FIGS. 7 and 8.

The text extractor 422 can extract a text from the frame selected by the frame selector 421. How the text extractor 422 extracts a text can be implemented using at least some of the various known technologies. For example, the text extractor 422 can extract a text using, for example, Optical Character Recognition (OCR), but the present disclosure is not limited thereto.

The media information requester 424 can request media information by using the text extracted by the text extractor 422 as a keyword. In accordance with certain embodiments of the present disclosure, the media information requester 424 can request media information stored in the storage unit 410 of the media content playback device 110, or can request media information from the media information server 130 through the communication unit 450. The media information requester 424 can request media information through the communication network 120 by forming, as query information, a variety of information collected or extracted to request the media information.

The communication unit 450, which provide a network communication function of the media content playback device 110, can send a message for requesting a search for media information from the media information requester 424, to the media information server 130, and receive media information searched for by the media information server 130.

In accordance with certain embodiments of the present disclosure, the media information requester 424 can request media information using the text, which is extracted from a frame by the text extractor 422. In accordance with various embodiments of the present disclosure, the media information requester 424 can request media information by transmitting information (e.g., metadata) related to media content, which is stored in the storage unit 410. In accordance with certain embodiments of the present disclosure, the media information requester 424 can further receive related information (e.g., time information of a frame, order information of a frame, and the like) about the selected frame, which is provided by the frame information collector 423, and transmit it to the media information server 130, thereby obtaining more accurate media information. In other words, the frame information collector 423 can be implemented to collect frame-related information for the frame selected by the frame selector 421, and provide it to the media information requester 424 to request the search.

The media information receiver 425 can receive the media information requested by the media information requester 424, and provides it to the media playback processor 426.

The media playback processor 426 can play the media content that is selected as the user requests playback of media content through the input unit 440, and display the media content on the display unit (e.g., a screen) 430. The media playback processor 426 can display on the display unit 430 even the media information related to the media content, which is received through the media information receiver 425. For example, if the media information received through the media information receiver 425 is subtitle information, the subtitle information can be synchronized with the media content and displayed on the screen, during playback of the media content.

Upon request for playback of specific media content that the user has selected through the input unit 440, the media playback processor 426 can perform the media playback process in real time together with a process of searching for media information related to the selected media content according to certain embodiments of the present disclosure. Therefore, the media playback processor 426 can control the frame selector 421 to select a specific frame for the search from the selected media content.

Although it is assumed in FIG. 4 that a search for related media information is requested if playback of media content is requested by the media playback processor 426, a procedure for searching for media information related to media content can be implemented to be performed apart from the playback of media content, as described above.

The controller 420 can include a Central Processing Unit (CPU), a Read Only Memory (ROM) that stores a control program for control of the media content playback device 110, and a Random Access Memory (RAM) that memorizes signals or data received from the outside and/or is used as a working space for operations performed in the device. The CPU can include a single-core CPU, a dual-core CPU, a triple-core CPU, a quad-core CPU, or the like. The CPU, the ROM and the RAM can be connected to one another via an internal bus.

The controller 420 can control the storage unit 410, the input unit 440, the communication unit 450 and the display unit 430.

In accordance with various embodiments of the present disclosure, the controller 420 can display, on the display unit 430, the media content requested to be played and the media information that is received as a result of the search, and can also perform various functions related to the screen information depending on the input signal from the input unit 440 (e.g., an Input/Output (I/O) module).

In accordance with certain embodiments of the present disclosure, in addition to the user input through a touch screen, the input unit 440 can include a gesture input through a camera module, a switch/button input through a button/keypad, a voice input through a microphone, a remote input through a remote controller, and the like.

The communication unit 450, under control of the controller 420, can connect the media content playback device 110 to the external electronic device (e.g., the media information server 130) by wireless communication using at least one or multiple antennas. The communication unit 450 can include at last one of a Wireless Local Area Network (WLAN) module and a short-range communication module. For example, the communication unit 450 can include any one or both of the WLAN module and the short-range communication module.

The WLAN module, under control of the controller 420, can access the Internet in the place where a wireless Access Point (AP) is installed. The WLAN module can support the WLAN standard IEEE 802.11x proposed by the Institute of Electrical and Electronics Engineers (IEEE). The short-range communication module, under control of the controller 420, can wirelessly perform short-range communication between the media content playback device 110 and the external electronic device. The short-range communication scheme can include Bluetooth, Infrared Data Association (IrDA), Wireless Fidelity (WiFi) Direct, Near Field Communication (NFC), and the like.

In accordance with certain embodiments of the present disclosure, the media content playback device 110 can communicate with the media information server 130 by any one of a mobile communication module, a sub-communication module and a WLAN module.

A multimedia module can be incorporated into the controller 420, and the media playback processor 426 can correspond to the multimedia module. For example, the multimedia module can include an audio playback module and a video playback module. The audio playback module, under control of the controller 420, can play the digital audio files (with a file extension of, e.g., mp3, wma, ogg or way) which are stored in the storage unit 410 or received from the outside. The video playback module, under control of the controller 420, can play the digital video files (with a file extension of, e.g., mpeg, mpg, mp4, avi, mov, or mkv) which are stored in the storage unit 410 or received from the outside.

The input unit (or I/O module) 440 can include at least one of at least one button, at least one microphone, at least one vibration device, a connector, a keypad, and a keyboard. The I/O module is not limited to these components, can be provided to control the movement of a cursor on the cursor control display (e.g., the screen) for a mouse, a trackball, a joystick, cursor arrow keys or the like.

The storage unit 410, under control of the controller 420, can store signals or data, which are received or to be output. The storage unit 410 can store applications and a control program for control of the media content playback device 110 by the controller 420.

The term ‘storage unit’ as used herein may refer to any data storage device such as the storage unit 410, a ROM and a RAM in the controller 420, and/or a memory card (e.g., a Secure Digital (SD) card, a memory stick and the like) mounted in the media content playback device 110. The storage unit 410 can include a non-volatile memory, a volatile memory, a Hard Disk Drive (HDD) or a Solid State Drive (SSD).

The storage unit 410 is a machine (e.g., computer)-readable medium, and the term ‘machine-readable medium’ as used herein may refer to a medium that provides data to machine so that the machine can perform a specific function. The storage 410 can include non-volatile media and volatile media. All of these media must be a type of media from which commands delivered by the media can be detected by the physical mechanism that reads the commands by machine.

The machine-readable medium can include, though not limited to, at least one of floppy disk, flexible disk, hard disk, magnetic tape, Compact Disc Read-Only Memory (CD-ROM), optical disk, punch card, paper tape, RAM, Programmable Read-Only Memory (PROM), Erasable PROM (EPROM), flash EPROM, and embedded Multi Media Card (eMMC).

So far, the media content playback device 110 has been described in detail with reference to FIG. 4. Reference will now be made to FIG. 5 to describe in detail the media information server 130.

FIG. 5 is a block diagram illustrating a detailed structure of a media information server 130 according to certain embodiments of the present disclosure. Referring to FIG. 5, the media information server 130 can include a request information receiver 510, a media information searcher 520, and a media information transmitter 530.

The request information receiver 510 can receive a media information request message transmitted from the media content playback device 110. The media information request message can include at least one keyword information (e.g., at least one text information extracted from a specific frame) for a search for media information, image information, and various metadata related to media content.

The media information searcher 520 can search for media information based on the variety of information included in the received media information request message. The media information searcher 520 can search for media information that is stored in advance in the media information database 131. For example, the media information searcher 520 can determine to which media content the variety of received information corresponds, among the plurality of media contents stored in the media information database 131. Thereafter, if it is determined that the received information corresponds to specific media content, the media information searcher 520 transmits media information (e.g., subtitle information) mapped to the media content to the media content playback device 110 through the media information transmitter 530.

The components of the media content playback device 110 and/or the media information server 130 illustrated in conjunction with FIGS. 4 and 5 are separately illustrated in the drawings to show that they can be separated in terms of function and logic, but it is not meant that they need to be implemented as physically separate components or separate codes.

The term ‘˜unit’ as used herein may refer to a functional or structural combination of hardware for implementing the technical aspects of the present disclosure and software for driving the hardware. For example, each unit may mean a logical unit of predetermined code and hardware resources for implementing the predetermined code, but it will be apparent to those of ordinary skill in the art that the unit does not necessarily mean a physically connected code or one type of hardware.

So far, the detailed structure of the media content playback device 110 and the media information server 130 constituting the system proposed by the disclosure has been described in detail. Reference will now be made to FIGS. 6 to 19 to describe in detail specific examples of searching for media information related to media content disclosure according to certain embodiments of the present disclosure.

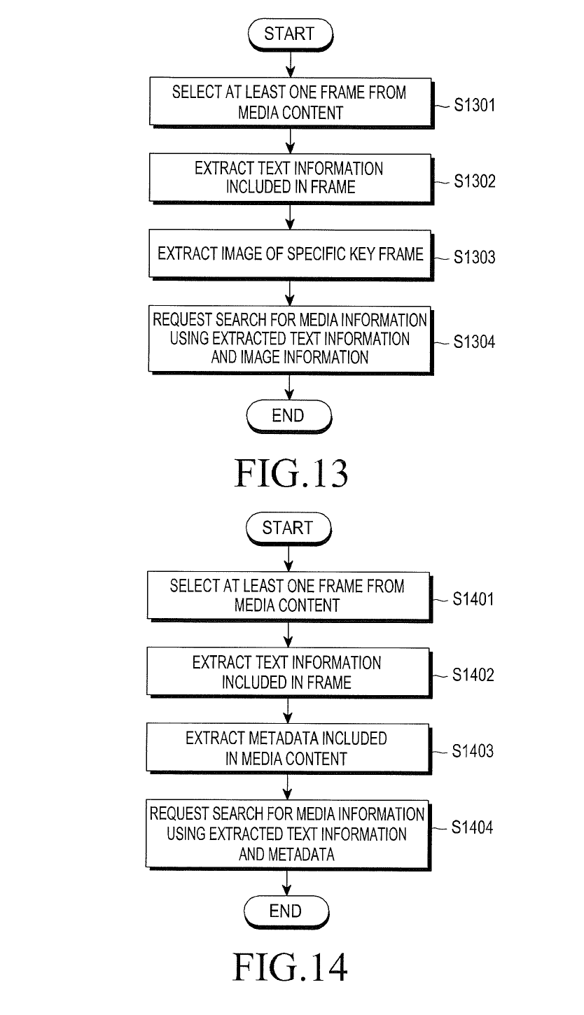

Reference will first be made to FIGS. 6 to 12 to describe in detail various examples of selecting a frame for extraction of a text used for a search for media information disclosure according to certain embodiments of the present disclosure. Reference will next be made to FIGS. 13 to 19 to describe in detail examples of a variety of information used for a search for media information according to certain embodiments of the present disclosure.

FIG. 6 illustrates a procedure for searching for media information related to media content according to certain embodiments of the present disclosure. Referring to FIG. 6, at least one frame is selected from specific media content including a plurality of frames (step S601). Specific examples of how to select the frame will be described below.

Thereafter, text information included in the selected frame is extracted (step S602). Each frame included in the media content can be an image frame, and how to extract a text included in the image in this step can be implemented in various ways. For example, as described above, the text information can be extracted from each frame image by parsing using an OCR technique.

Next, a search for media information is requested using the extracted text information (step S603). It is assumed in FIG. 6 that media information is searched for using the extracted text information. In accordance with various embodiments of the present disclosure (e.g., as illustrated in FIGS. 13 to 16), a variety of information extracted from or included in media content can be used for the search for media information.

As such, if media information is searched for upon request for a search for media information and the media information corresponding to the search results is received, the received media information can be stored or displayed on the screen. In accordance with certain embodiments of the present disclosure, if the received media information is subtitle information, the subtitle information can be synchronized with each frame of the screen and displayed on the screen together with the media content during playback of the media content.

Reference will now be made to FIGS. 7 to 12 to describe examples of selecting frame information to extract a text used as information for a search for media information according to certain embodiments of the present disclosure.

FIG. 7 illustrates frames which are searched for beginning from a start frame according to certain embodiments of the present disclosure, and FIG. 8 illustrates frames which are searched for beginning from an end frame according to certain embodiments of the present disclosure.

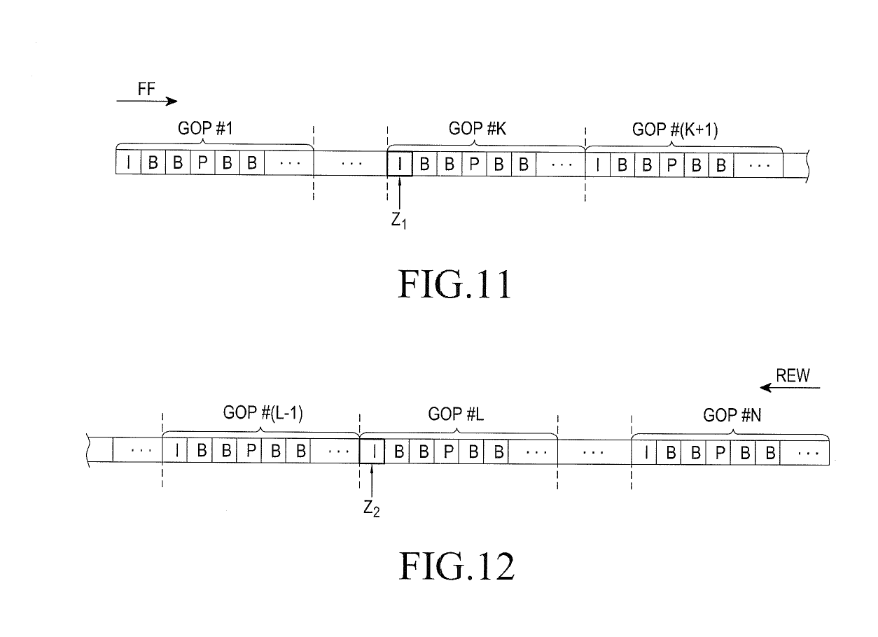

Referring to FIG. 7, frames are first examined or searched for in ascending order, beginning from a start frame (e.g., time 00:00) of media content in order to select a frame from which a text is to be extracted. The search for frames can be made for all frames, or can be made only for key frames. The search for frames can be made at regular intervals. A description of the key frames will be made below with reference to FIGS. 11 and 12.

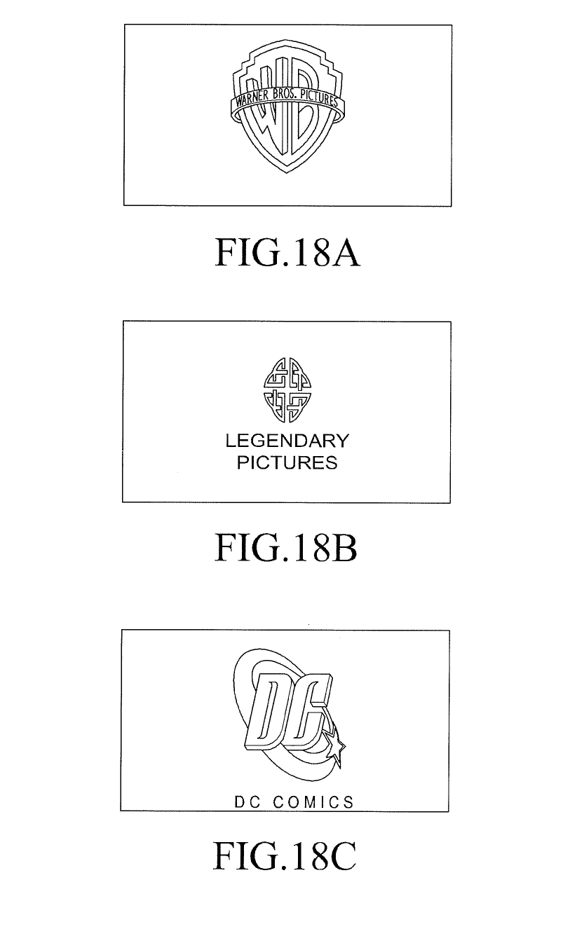

As such, the frames are searched for in ascending order to determine whether a text is included in the frames. In accordance with certain embodiments of the present disclosure, the first frame including a text is represented as Z₁. If the media content is movie videos, the frame Z₁ can be a screen that includes, as a text, a name of a film distributor as illustrated in FIG. 18A.

In accordance with certain embodiments of the present disclosure, X₁ frames can be selected in ascending order at intervals of a predetermined time Y beginning from the frame Z₁. Therefore, in the example of FIG. 7, X₁ frames of Z₁, Z₁+Y, Z₁+2Y, . . . , Z₁+(X₁−1)Y can be selected.

Text extraction is performed on each of the selected X₁ frames according to certain embodiments of the present disclosure. Information about at least one extracted text can be used as a search keyword for a search for media information related to the media content.

The ascending search for frames can be implemented using the Fast Forwarding (FF) function of the media content playback device, but the present disclosure is not limited thereto.

Referring next to FIG. 8, frames are first examined or searched for in descending order, beginning from an end frame (or the last frame) of media content in order to select a frame from which a text is to be extracted. The search for frames can be made for all frames, or can be made only for key frames. The search for frames can be made at regular intervals. A description of the key frames will be made below with reference to FIGS. 11 and 12.

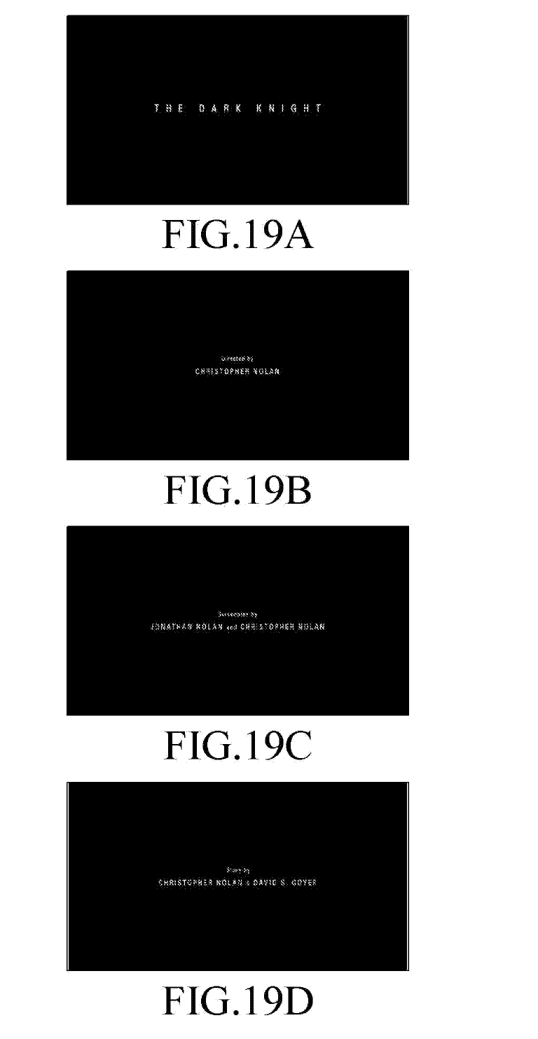

As such, the frames are searched for in descending order, beginning from the end frame to determine whether a text is included in the frames. In accordance with certain embodiments of the present disclosure, the first frame including a text is represented as Z₂. If the media content is movie videos, the frame Z₂ can be a screen that includes, as a text, a name of the film as illustrated in FIG. 19A.

In accordance with certain embodiments of the present disclosure, X₂ frames can be selected in descending order at intervals of a predetermined time Y beginning from the frame Z₂. Therefore, in the example of FIG. 8, X₂ frames of Z₂, Z₂−Y, Z₂−2Y, . . . , Z₂−(X₂−1)Y can be selected.

Text extraction is performed on each of the selected X₂ frames according to certain embodiments of the present disclosure. Information about at least one extracted text can be used as a search keyword for a search for media information related to the media content.

The descending search for frames can be implemented using the Rewinding (REW) function of the media content playback device, but the present disclosure is not limited thereto.

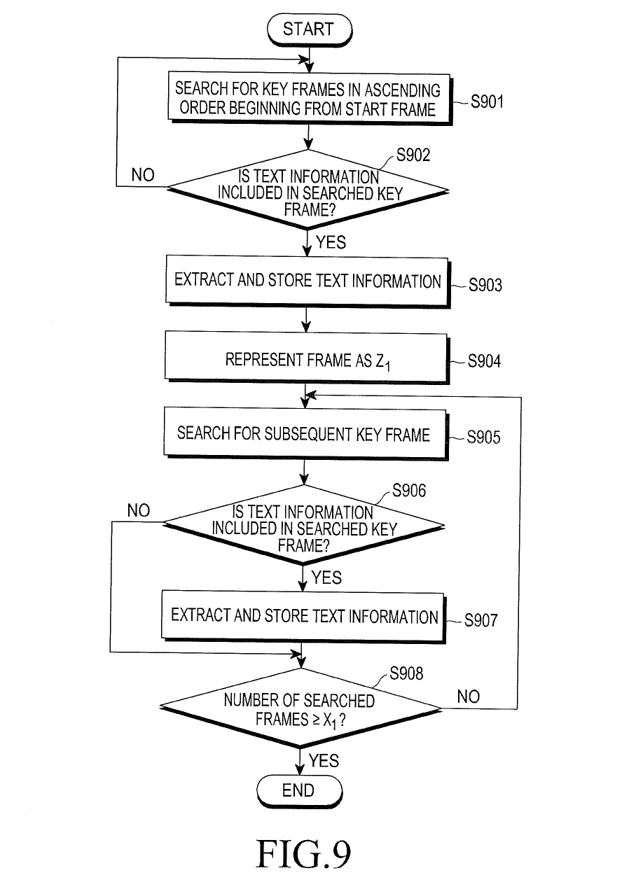

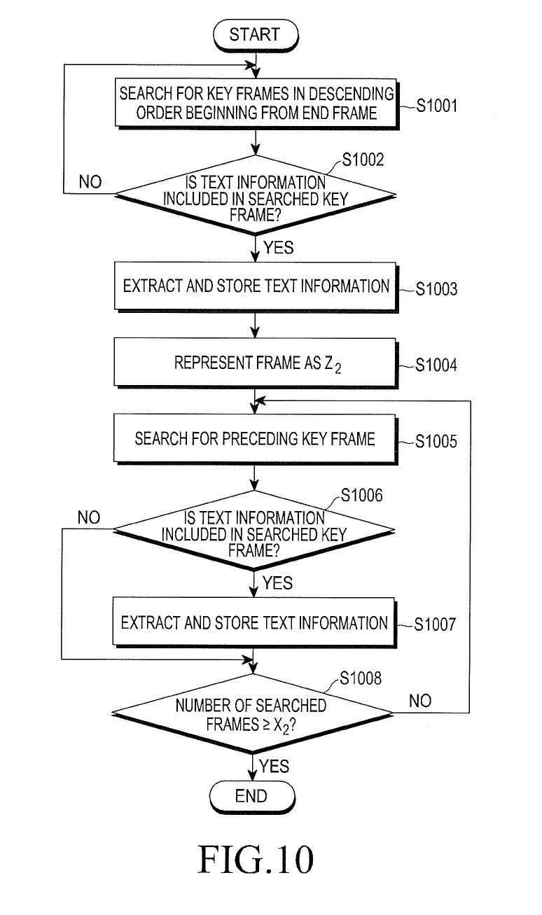

FIG. 9 illustrates a procedure for extracting a text by searching for frames in ascending order, beginning from a start frame according to certain embodiments of the present disclosure. FIG. 10 illustrates a procedure for extracting a text by searching for frames in descending order, beginning from an end frame according to certain embodiments of the present disclosure. Referring to FIGS. 9 and 10, a text can be extracted by selecting a frame in the methods of FIGS. 7 and 8, respectively.

Referring to FIGS. 7 and 9, a key frame is first searched for in ascending order, beginning from a start frame (step S901). If no text information is included in the searched key frame (No in step S902), a next key frame is searched for.

If text information is included in the searched key frame (Yes in step S902), the included text information is extracted and stored (step S903), and the frame is represented as Z₁ (step S904).

Thereafter, a subsequent key frames are searched for at intervals of a preset time Y (e.g., Y seconds) (step S905). If text information is included in the searched key frame (Yes in step S906), the text information is extracted and stored (step S907).

The search procedure for key frames is repeatedly performed every Y time (or Y seconds), and if the number of searched frames is greater than or equal to a predetermined number X1 (Yes in step S908), the text information extraction procedure is ended. In this way, a predetermined number of texts can be effectively extracted at the beginning of the media content. In other words, generally, in the case of movie videos, the key information related to the movie, such as distributor, movie title, main actors and the like, can be included at the beginning of the movie as texts in the movie screen as illustrated in FIGS. 18A to 18C. Therefore, in certain embodiments of the present disclosure, the key information related to media content can be obtained by first searching for the first frame including a text beginning in ascending order from a start frame and extracting texts included in the frames which succeed the searched frame for a predetermined period of time.

Referring next to FIGS. 8 and 10, a key frame is first searched for in descending order, beginning from an end frame or the last frame (step S1001). If no text information is included in the searched key frame (No in step S1002), a preceding key frame is searched for.

If text information is included in the searched key frame (Yes in step S1002), the included text information is extracted and stored (step S1003), and the frame is represented as Z₂ (step S1004).

Thereafter, the preceding key frames are searched for at intervals of a preset time Y (e.g., Y seconds) (step S1005). If text information is included in the searched key frame (Yes in step S1006), the text information is extracted and stored (step S1007).

The search procedure for key frames is repeatedly performed every Y time (or Y seconds), and if the number of searched frames is greater than or equal to a predetermined number X₂ (Yes in step S1008), the text information extraction procedure is ended. In this way, a predetermined number of texts can be effectively extracted at the end of the media content. In other words, generally, in the case of movie videos, the key information related to the movie, such as starring actors, staffs, movie title and the like, can be included at the end of the movie as texts in the movie screen as illustrated in FIGS. 19A to 19D. Therefore, in certain embodiments of the present disclosure, the key information related to media content can be obtained by first searching for the first frame including a text beginning in descending order from an end frame and extracting texts included in the frames which precede the searched frame for a predetermined period of time.

FIGS. 11 and 12 illustrate text extraction from key frames according to certain embodiments of the present disclosure. As described above, a frame can be examined or searched for among a plurality of frames included in media content at intervals of a predetermined time, and if frames of media content is configured in the form of Group of Pictures (GOP) as illustrated in FIGS. 11 and 12, text information can be effectively extracted by examining only specific key frames (e.g., I-frames in FIGS. 11 and 12).

GOP is compression technology for adjusting the number of I-frames, P-frames and B-frames during video compression, to thereby reduce the size of video while minimizing the image degradation. The I-frame, a basic frame for video compression, is also called a key frame, and it can form one complete image. The P-frames and B-frames are frames that have information about only the part (e.g., a moving part) which has changed compared to the I-frame. If the number of I-frames is large, the image quality can improve, but the bit rate and the file size can increase. Therefore, during video compression, the video, which can have a lot of movements and whose scene is significantly changed, can be high in bit rate and large in file size, compared to the video (e.g., video with a less number of I-frames) which has almost no movement as it has a large number of I-frames.

In the examples of FIGS. 11 and 12, one GOP is comprised of one I-frame and a plurality of P-frames and B-frames. Therefore, in certain embodiments of the present disclosure, extraction of text information can be performed only for the I-frames which are key frames.

Therefore, referring to FIG. 11, in accordance with certain embodiments of the present disclosure, an I-frame is examined in ascending order, beginning from the I-frame of the first GOP to determine whether a text is included in the I-frame. If it is determined that as illustrated, a text is extracted for the first time from an I-frame of a K-th GOP, the I-frame of the K-th GOP can be represented as Z₁. Thereafter, as described above, the succeeding I-frame can be examined at intervals of a time Y, or every I-frame can be examined.

Similarly, referring to FIG. 12, in accordance with certain embodiments of the present disclosure, an I-frame is examined in descending order, beginning from an I-frame of an N-th GOP, which is the last frame of the media content, to determine whether a text is included in the I-frame. If it is determined that as illustrated, a text is extracted for the first time from an I-frame of an L-th GOP, the I-frame of the L-th GOP can be represented as Z₂. Thereafter, as described above, the preceding I-frame can be examined at intervals of a time Y, or every I-frame can be examined.

Reference will now be made to FIGS. 13 to 16 to describe in detail methods of searching for media information using a variety of information according to certain embodiments of the present disclosure. For example, in the following description, media information search methods according to four different embodiments will be presented, but the present disclosure will not be limited to the following embodiments.

FIG. 13 illustrates a procedure for searching for media information related to media content according to a certain embodiments of the present disclosure. Referring to FIG. 13, at least one frame is selected from specific media content including a plurality of frames as in the above described methods (step S1301).

Thereafter, text information included in the selected frame is extracted (step S1302). Each frame included in the media content can be an image frame, and how to extract a text included in an image in each step can be implemented in various ways as described above.

Next, at least one image is extracted from a specific key frame according to certain embodiments of the present disclosure (step S1303). Since one frame can form one image, the extracted image information can correspond to its associated frame itself. The specific frame, from which an image is extracted, can be at least one frame, from which the text information is extracted. Alternatively, it can be a frame corresponding to a predetermined specific time or a frame having a predetermined order.

Thereafter, a search for media information is requested using the extracted text information and image information (step S1304). In this way, by making a search for media information using the image information in addition to the text information extracted from a specific frame, it is possible to further increase the accuracy of the search compared to if it makes the search using only the text information.

If the media information is searched for at the request for a search for media information and the media information corresponding to the search results is received, the received media information can be stored or displayed on the screen.

In accordance with various embodiments of the present disclosure, the media information server 130 can search for media information using both the transmitted text information and image information. In certain embodiments of the present disclosure, the media information server 130 can be implemented to search for media information by first using the text information, and then re-search for media information by using the image information if the search is failed.

In accordance with certain embodiments of the present disclosure, if the received media information is subtitle information, the subtitle information can be synchronized with a frame of each screen and displayed on the screen together with the media content during playback of the media content, as described above.

FIG. 14 illustrates a procedure for searching for media information related to media content according to certain embodiments of the present disclosure. Referring to FIG. 14, at least one frame is selected from specific media content including a plurality of frames as in the above described methods (step S1401).

Thereafter, text information included in the selected frame is extracted (step S1402). Each frame included in the media content can be an image frame, and how to extract a text included in an image in each step can be implemented in various ways as described above.

Next, metadata included in the media content is extracted according to the second embodiment of the present disclosure (step S1403). The metadata, as described above, is information which is included in or related to media content, and can be included in a media content file. For example, the metadata can include information about at least one of a file name, a running time, a frame size, an audio data size, a video data size, a frame rate, an aspect ratio of pixels, key frame information, a video codec, an audio codec, and the like.

Thereafter, a search for media information is requested using the extracted text information and metadata (step S1404). In this way, by making a search for media information using the metadata in addition to the text information extracted from a specific frame, it is possible to further increase the accuracy of the search compared to if it makes the search using only the text information.

If the media information is searched for at the request for a search for media information and the media information corresponding to the search results is received, the received media information can be stored or displayed on the screen. In accordance with certain embodiments of the present disclosure, if the received media information is subtitle information, the subtitle information can be synchronized with a frame of each screen and displayed on the screen together with the media content during playback of the media content, as described above.

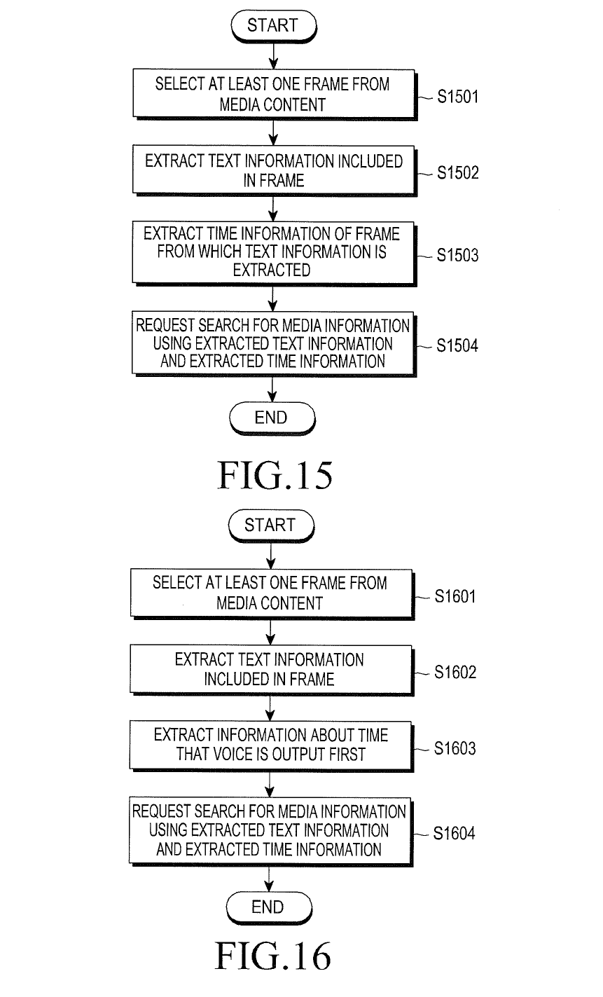

FIG. 15 illustrates a procedure for searching for media information related to media content according to certain embodiments of the present disclosure. Referring to FIG. 15, at least one frame is selected from specific media content including a plurality of frames as in the above described methods (step S1501).

Thereafter, text information included in the selected frame is extracted (step S1502). Each frame included in the media content can be an image frame, and how to extract a text included in an image in each step can be implemented in various ways as described above.

Next, time information of the frame, from which the text information is extracted, is detected according to the third embodiment of the present disclosure (step S1503).

Thereafter, a search for media information is requested using the extracted text information and the detected time information (step S1504). In this way, by making a search for media information using the time information in addition to the text information extracted from a specific frame, it is possible to further increase the accuracy of the search compared to if it makes the search using only the text information.

If the media information is searched for at the request for a search for media information and the media information corresponding to the search results is received, the received media information can be stored or displayed on the screen. In accordance with certain embodiments of the present disclosure, if the received media information is subtitle information, the subtitle information can be synchronized with a frame of each screen and displayed on the screen together with the media content during playback of the media content, as described above.

FIG. 16 illustrates a procedure for searching for media information related to media content according to certain embodiments of the present disclosure. Referring to FIG. 16, at least one frame is selected from specific media content including a plurality of frames as in the above described methods (step S1601).

Thereafter, text information included in the selected frame is extracted (step S1602). Each frame included in the media content can be an image frame, and how to extract a text included in an image in each step can be implemented in various ways as described above.

Next, information about the time a voice is first output is detected from the media content according to the fourth embodiment of the present disclosure (step S1603). The information about the time a voice is first output can be meaningful information. For example, in the case of a general movie video file, only background music can be output without voice at the beginning of the playback of the video. Thereafter, after a lapse of predetermined time, characters appearing in the movie can appear on the screen, or a voice can be output by narration. As such, if a voice is first output after the start of the movie, subtitle information can be output together with the voice, and meaningful text information can be displayed on the screen together with the voice and subtitle information. Therefore, the accuracy of the search can be increased by detecting the information about the time a vice is first output, from media content according to the fourth embodiment of the present disclosure and using the detected time information as information for the search.

How to detect the information about the time a voice is first output can be implemented in various ways. For example, the time that a frequency (e.g., 100 Hz˜5 KHz) corresponding to the human voice is detected first from the voice data of media content can be determined as the information about the time a voice is first output. However, the present disclosure is not limited thereto.

Thereafter, a search for media information is requested using the extracted text information and the detected time information (step S1604). In this way, by making a search for media information using the information about the time a voice is first output, in addition to the text information extracted from a specific frame, it is possible to further increase the accuracy of the search compared to if it makes the search using only the text information.

If the media information is searched for at the request for a search for media information and the media information corresponding to the search results is received, the received media information can be stored or displayed on the screen. In accordance with certain embodiments of the present disclosure, if the received media information is subtitle information, the subtitle information can be synchronized with a frame of each screen and displayed on the screen together with the media content during playback of the media content, as described above.

So far, the media information search methods according to various embodiments of the present disclosure have been described with reference to FIGS. 13 to 16.

The media content-related information search method according to certain embodiments of the present disclosure can be implemented in the form of program instructions capable of being executed by means of various computers, and can be recorded in a computer-readable medium. The computer-readable medium can include or record program commands, data files, a data structure and the like independently or in combination. The program commands recorded in the medium can be commands which are designed and configured especially for the present disclosure, or commands which are known to those skilled in the art of computer software. Examples of the computer-readable recording medium can include magnetic media such as hard disk, floppy disk and magnetic tape; optical media such as Compact Disk Read Only Memory (CD-ROM) and Digital Versatile Disk (DVD); magneto-optical media such as floptical disk; and hardware devices specially configured to store and execute program commands, such as ROM, RAM and flash memory. Examples of program commands can include not only machine code which is made by a compiler, but also high-level language code which can be executed by a computer using an interpreter and the like. The hardware device can be configured to operate as one or more software modules to perform the operation of the present disclosure, and vice versa.

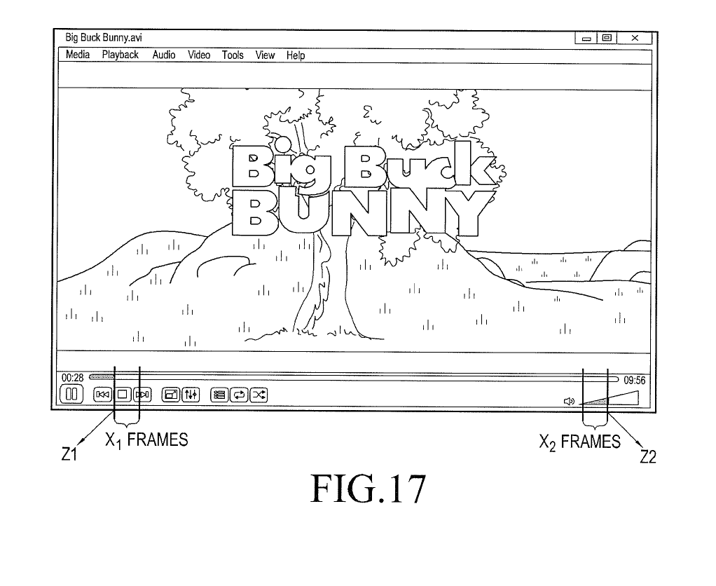

Reference will now be made to FIGS. 17 to 19 to describe an example of selecting a frame on an actual media content playback screen according to certain embodiments of the present disclosure.

FIG. 17 illustrates a frame which is searched for beginning from a start frame and an end frame on a media content playback screen according to certain embodiments of the present disclosure. Referring to FIG. 17, as described above, if each frame is searched for in ascending order, beginning from a start frame and the first frame including a text (e.g., a frame including a text “Big Buck BUNNY”) is detected as illustrated in the drawing, the detected frame can be represented as Z₁. Thereafter, a text included X₁ frames is extracted at intervals of a predetermined time Y beginning from the Z₁, and can be used as information for a search for media information.

Similarly, as described above, if each frame is searched for in descending order, beginning from an end frame and the first frame including a text is detected as illustrated in the drawing, the detected frame can be represented as Z₂. Thereafter, a text included X₂ frames is extracted at intervals of a predetermined time Y beginning from the Z₂, and can be used as information for a search for media information.

FIGS. 18A to 18C illustrate frames which are searched for in ascending order, beginning from a start frame and in which texts are included. Referring to FIGS. 18A to 18C, if each frame is searched for in ascending order, beginning from a start frame as in FIG. 17, the first frame including a text can be detected as in FIG. 18A. Thereafter, if a frame is detected at intervals of a predetermined time, frames including a text can be detected as in FIGS. 18B and 18C.

As such, media information related to media content can be effectively searched for by extracting at least one text from frames including a text.

FIGS. 19A to 19D illustrate frames which are searched for in descending order, beginning from an end frame and in which texts are included. Referring to FIGS. 19A to 19D, if each frame is searched for in descending order, beginning from an end frame as in FIG. 17, the first frame including a text can be detected as in FIG. 19A. Thereafter, if a frame is detected at intervals of a predetermined time, frames including a text can be detected as in FIGS. 19B and 19D.

As such, media information related to media content can be effectively searched for by extracting at least one text from frames each including a text.

As is apparent from the foregoing description, according to embodiments of the present disclosure, the most-correct and appropriate media information can be automatically searched for by extracting text information included in a specific frame in media content and searching for related media information using the extracted text information.

In addition, the most-correct and appropriate media information can be automatically searched for by searching for related media information in combination of text information included in a specific frame in media content and various other media content-related information (e.g., metadata, an image of a specific key frame, time information of a frame from which text information is extracted, information about the time a voice is first output, and the like).

Besides, the reliability of the search for media information can be improved by not simply depending only on the file name of media content in searching for the media content-related information.

Although the present disclosure has been described with certain embodiments, various changes and modifications may be suggested to one skilled in the art. It is intended that the present disclosure encompass such changes and modifications as fall within the scope of the appended claims.

What is claimed is:

1. A method for searching for media information related to media content, comprising:
selecting at least one frame from a plurality of frames included in the media content;
extracting at least one text information included in each of the selected at least one frame; and
requesting the media information related to the media content using the extracted at least one text information.

2. The method of claim 1, wherein the media information related to the media content includes subtitle information of the media content.

3. The method of claim 1, wherein the selecting of the at least one frame comprises:
searching for key frame in ascending order, beginning from a start frame of the media content; and
selecting a first key frame including a text.

4. The method of claim 3, further comprising:
after selecting the first key frame including a text, selecting a predetermined number of subsequent key frames which are separated from each other by a preset time interval.

5. The method of claim 1, wherein selecting the at least one frame comprises:
searching for key frame in descending order, beginning from an end frame of the media content; and
selecting a first key frame including a text.

6. The method of claim 5, further comprising:
after selecting the first key frame including a text, selecting a predetermined number of preceding key frames which are separated from each other by a preset time interval.

7. The method of claim 1, further comprising:
extracting at least one image included in the media content; and
requesting the media information related to the media content using the extracted at least one image in addition to the extracted at least one text information.

8. The method of claim 7, wherein extracting the at least one image comprises:
extracting an image corresponding to a preset time of a total running time of the media content.

9. The method of claim 1, further comprising:
extracting at least one metadata included in the media content; and
requesting the media information related to the media content using the extracted at least one metadata in addition to the extracted at least one text information.

10. The method of claim 9, wherein the metadata includes information about any selected one of a file name, a running time, a frame size, an audio data size, a video data size, a frame rate, an aspect ratio of pixels, key frame information, a video codec, and an audio codec.

11. The method of claim 1, further comprising:
extracting time information of a frame from which the text information is extracted; and
requesting the media information related to the media content using the extracted time information in addition to the extracted at least one text information.

12. The method of claim 1, further comprising:
extracting information about a time that a voice is first output, from the media content; and
requesting the media information related to the media content using the extracted time information in addition to the extracted at least one text information.

13. An apparatus for searching for media information related to media content, comprising:
a storage unit configured to store information about at least one media content; and
a controller configured to select at least one frame from a plurality of frames included in the media content, extract at least one text information included in each of the selected at least one frame, and request media information related to the media content using the extracted at least one text information.

14. The apparatus of claim 13, wherein the media information related to the media content includes subtitle information of the media content.

15. The apparatus of claim 13, wherein the controller is configured to search for key frame in ascending order, beginning from a start frame of the media content, and select a first key frame including a text.

16. The apparatus of claim 15, wherein after selecting the first key frame including a text, the controller is configured to select a predetermined number of subsequent key frames which are separated from each other by a preset time interval.

17. The apparatus of claim 13, wherein the controller is configured to search for key frame in descending order, beginning from an end frame of the media content, and select a first key frame including a text.

18. The apparatus of claim 17, wherein after selecting the first key frame including a text, the controller is configured to select a predetermined number of preceding key frames which are separated from each other by a preset time interval.

19. The apparatus of claim 13, wherein the controller is configured to extract at least one image included in the media content, and request the media information related to the media content using the extracted at least one image in addition to the extracted at least one text information.

20. The apparatus of claim 19, wherein the controller is configured to extract an image corresponding to a preset time of a total running time of the media content.

21. The apparatus of claim 13, wherein the controller is configured to extract at least one metadata included in the media content, and request the media information related to the media content using the extracted at least one metadata in addition to the extracted at least one text information.

22. The apparatus of claim 21, wherein the metadata includes information about any selected one of a file name, a running time, a frame size, an audio data size, a video data size, a frame rate, an aspect ratio of pixels, key frame information, a video codec, and an audio codec.

23. The apparatus of claim 13, wherein the controller is configured to extract time information of a frame from which the text information is extracted, and request the media information related to the media content using the extracted time information in addition to the extracted at least one text information.

24. The apparatus of claim 13, wherein the controller is configured to extract information about a time that a voice is first output, from the media content, and request the media information related to the media content using the extracted time information in addition to the extracted at least one text information.

25. A media information server for providing media information related to media content, comprising:
a media information database in which at least one media information is stored by being mapped to each media content;
a request information receiver configured to receive a media information request message transmitted from each media content playback device;
a media information searcher configured to search for media information stored in the media information database using at least one information included in the received media information request message; and
a media information transmitter configured to transmit the media information searched for by the media information searcher to the media content playback device;
wherein the media information request message includes text information that is extracted from at least one frame selected from the media content including a plurality of frames.

26. The media information server of claim 25, wherein the media information request message further includes at least one image information extracted from the media content; and
wherein the media information searcher is configured to re-search for media information using the image information if the media information searcher fails to search for media information using text information included in the received media information request message.

27. A computer-readable storage medium storing a set of executable instructions, which if executed by a processor, cause the processor to:
select at least one frame from a plurality of frames included in the media content;
extract at least one text information included in each of the selected at least one frame; and
request media information related to the media content using the extracted at least one text information.
